(19) United States
(12) Patent Application Publication
(10) Pub. No.: US 2016/0124523 A1
(43) Pub. Date: May 5, 2016

(54) ELECTRONIC DEVICE, DISPLAY DEVICE, AND METHOD FOR CONTROLLING THE SAME

(71) Applicant: SAMSUNG ELECTRONICS CO., LTD., Suwon-si (KR)

(72) Inventors: Byuk-sun KIM, Seoul (KR); Hyun-kyu YUN, Seoul (KR); Young-deok KIM, Anyang-si (KR); Sang-hoon EUM, Seoul (KR); Myoung-jun LEE, Bucheon-si (KR); Byung-jo JUN, Seongnam-si (KR); Jae-won JUNG, Seoul (KR)

(73) Assignee: SAMSUNG ELECTRONICS CO., LTD., Suwon-si (KR)

(21) Appl. No.: 14/800,840

(22) Filed: Jul. 16, 2015

(30) Foreign Application Priority Data
Nov. 3, 2014 (KR) 10-2014-0151008

(51) Int. Cl. G06F 3/0346; G06F 3/00; G06K 9/62; G06F 3/0481; G06F 3/0487

(52) U.S. Cl. CPC G06F 3/0346; G06F 3/04817; G06F 3/0487; G06K 9/6215; G06F 3/005; G06F 2203/0384

(57) ABSTRACT

An electronic device, a display device, and a method for controlling the same are provided. The method for controlling an electronic device includes communicating with a display device that displays content; sensing a motion of the electronic device, and determining whether the electronic device is in an alignment state for providing a content service from the display device based on the result of motion sensing; transmitting an event signal that includes alignment state information to the display device if the electronic device is in the alignment state; and displaying content information about the content that is received from the display device. Accordingly, the electronic device can receive the content information related to the content that is being displayed on the display device more intuitively and quickly.

### CROSS-REFERENCE TO RELATED APPLICATION

This application claims priority from Korean Patent Application No. 10-2014-0151008, filed on Nov. 3, 2014, in the Korean Intellectual Property Office, the disclosure of which is incorporated herein by reference.

### BACKGROUND

1. Field

Methods and apparatuses consistent with exemplary embodiments of the present application relate to providing content on a display device intuitively and conveniently.

2. Description of the Related Art

In order to receive, on a portable terminal device, content information that is related to content displayed on a display device, a user can press a specific button provided on the portable terminal device to request a content service from the display device.

In accordance with a content service request command, the portable terminal device can request the content service from the display device, and the display device can transmit the content information that is related to the content that is currently being viewed to the portable terminal device. Accordingly, the user can view the content only through the display device, and can confirm the content information that is additional information related to the corresponding content through the portable terminal device.

However, in order to receive the content information that is provided from the display device through the portable terminal device, it may require performing complicated procedures, such as communication connection between the display device and the portable terminal device and the content service request.

Accordingly, an age group that is not good at performing operations related to the content service may be unable to use the corresponding content, and also may be unable to use the content service promptly and quickly.

### SUMMARY

One or more exemplary embodiments solve the above-described problems and provide an electronic device that can receive content information provided from an external terminal device more intuitively and quickly.

According to an aspect of an exemplary embodiment, there is provided a method of controlling an electronic device, the method including communicating with a display device that displays content; sensing a motion of the electronic device; determining whether the electronic device is in an alignment state based on the motion sensing; transmitting an event signal that includes alignment state information to the display device; and receiving and displaying content information related to the displayed content.

The method may further include comparing a slope value sensed through the electronic device with a predetermined slope value, and determining that the electronic device is in the alignment state if the sensed slope value is equal to or larger than the predetermined slope value.

The method may further include measuring a similarity between an image of the display device that is captured through an image capturer of the electronic device and a predetermined image of the display device, and determining that the electronic device is in the alignment state if the measured similarity value is equal to or greater than a predetermined similarity value.

The method may further include sensing a distance between the electronic device and the display device through at least one of an ultrasonic sensor and a BLE (Bluetooth Low Energy) sensor, and determining that the electronic device is in the alignment state if the sensed distance is within a predetermined threshold distance.

The method may further include displaying an icon indicating that the content information has been received from the display device, and in response to receiving an input selection command for the displayed icon, displaying the content information related to the content.

The method may further include retransmitting the event signal to the display device if a response message is not received from the display device within a predetermined threshold time after the event signal is transmitted to the display device.

According to an aspect of another exemplary embodiment, there is provided a method of controlling a display device, the method including receiving an event signal from an electronic device; determining whether the received event signal includes alignment state information; and transmitting content information about content being displayed on the display device to the electronic device if the event signal includes the alignment state information.

The method may further include, if the received event signal includes motion information, determining whether the electronic device is in an alignment state according to whether a slope value included in the motion information of the electronic device is equal to or greater than a predetermined slope value, and transmitting the content information to the electronic device if the electronic device is in the alignment state.

The method may further include, if the received event signal does not include the alignment state information, sensing a distance between the electronic device and the display device through at least one of an ultrasonic sensor and a BLE (Bluetooth Low Energy) sensor, and determining that the electronic device is in the alignment state if the sensed distance is within a predetermined threshold distance, and transmitting the content information to the electronic device if the electronic device is in the alignment state.

The method may further include, if the received event signal does not include the alignment state information, determining whether the electronic device is in the alignment state according to a degree of similarity between an image of the electronic device that is captured through an image capturer provided in the display device and a predetermined image of the electronic device, and transmitting the content information to the electronic device if the electronic device is in the alignment state.

The method may further include, if the received event signal does not include the alignment state information, transmitting the content information to the electronic device if a content transmission command is input.

The method may further include transmitting a notification message indicating that the event signal has been received to the electronic device before the content information is transmitted.

The transmitting may include transmitting the content information using a communication method including at least one of Bluetooth, BLE (Bluetooth Low Energy), UPNP (Universal Plug and Play), HTTP (Hypertext Transfer Protocol), and Wi-Fi.

According to an aspect of another exemplary embodiment, there is provided an electronic device including a display; a sensor configured to sense a motion of the electronic device; a communicator configured to communicate with a display device that displays content; and a controller configured to determine whether the electronic device is in an alignment state for providing a content service from the display device based on a result of the motion sensing, transmit an event signal that includes alignment state information to the display device, and control the display to display content information related to the content that is displayed on the display device.

The controller may be further configured to compare a slope value that is sensed through the sensor with a predetermined slope value, and determine that the electronic device is in the alignment state if the sensed slope value is equal to or greater than the predetermined slope value.

The electronic device may further include an image capturer configured to capture an image, wherein the controller is further configured to measure a similarity between an image of the display device that is captured through the image capturer and a predetermined image of the display device, and determine that the electronic device is in the alignment state if the measured similarity value is equal to or greater than a predetermined similarity value.

The electronic device may further include an inputter configured to receive an input of a user command, wherein the controller is further configured to control the display to display an icon indicating that the content information has been received, and control the display to display the content information about the content displayed on the display device if a selection command for the displayed icon is input.

The controller may further be configured to, in response to not receiving a response message from the display device within a predetermined threshold time after the event signal is transmitted to the display device, control the communicator to retransmit the event signal to the display device.

According to an aspect of another exemplary embodiment, there is provided a display device including a display configured to display content; a communicator configured to receive an event signal from an electronic device; and a controller configured to control the communicator to, in response to receiving an event signal that includes alignment state information of the electronic device, transmit pre-stored content information that is related to the displayed content.

The controller may be further configured to, in response to the received event signal including motion information of the electronic device, determine whether the electronic device is in an alignment state depending on whether a slope value included in the motion information of the electronic device is equal to or greater than a predetermined slope value.

The display device may further include an image capturer configured to photograph an image, wherein the controller determines whether the electronic device is in the alignment state depending on the degree of similarity between a photographed image of the electronic device that is photographed through the image capturer and a predetermined image of the electronic device.

The controller may be further configured to, before transmitting the content information, control the communicator to transmit a notification message to the electronic device indicating that the event signal has been received.

The communicator may be further configured to transmit the content information using a communication method comprising at least one of Bluetooth, BLE (Bluetooth Low Energy), UPNP (Universal Plug and Play), HTTP (Hypertext Transfer Protocol), and Wi-Fi.

According to an aspect of another exemplary embodiment, there is provided a method including determining an alignment state of an electronic device; transmitting an event signal indicating the determined alignment state; receiving a confirmation signal indicating that the transmitted event signal was received by a display device; and receiving content information related to a program being displayed on the display device.

The determining the alignment state may include at least one of sensing a motion of the electronic device, capturing an image of the display device, and sensing a distance between the electronic device and the display device.

According to various exemplary embodiments of the present disclosure, the electronic device can receive the content information related to the content that is being displayed on the display device more intuitively and quickly.

### BRIEF DESCRIPTION OF THE DRAWINGS

The above and other aspects, features and advantages of the present disclosure will be more apparent from the following detailed description when taken in conjunction with the accompanying drawings, in which:

FIG. 1 is a block diagram illustrating the configuration of a system that provides a content service according to an exemplary embodiment;

FIG. 2 is a procedural diagram of a system that provides a content service according to an exemplary embodiment;

FIG. 3 is a block diagram of an electronic device according to an exemplary embodiment;

FIG. 4 is an exemplary view illustrating an alignment state between an electronic device and a display device according to an exemplary embodiment;

FIG. 5 is a first exemplary view of an electronic device that provides content information according to an exemplary embodiment;

FIG. 6 is a second exemplary view of an electronic device that provides content information according to another exemplary embodiment;

FIG. 7 is a block diagram of a display device according to an exemplary embodiment;

FIG. 8 is a flowchart illustrating a method for controlling an electronic device according to an exemplary embodiment; and

FIG. 9 is a flowchart illustrating a method for controlling a display device according to an exemplary embodiment.

### DETAILED DESCRIPTION

Hereinafter, one or more exemplary embodiments will be described in detail with reference to the accompanying drawings. Expressions such as “at least one of,” when preceding a list of elements, modify the entire list of elements and do not modify the individual elements of the list.

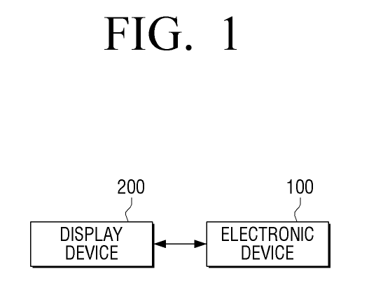

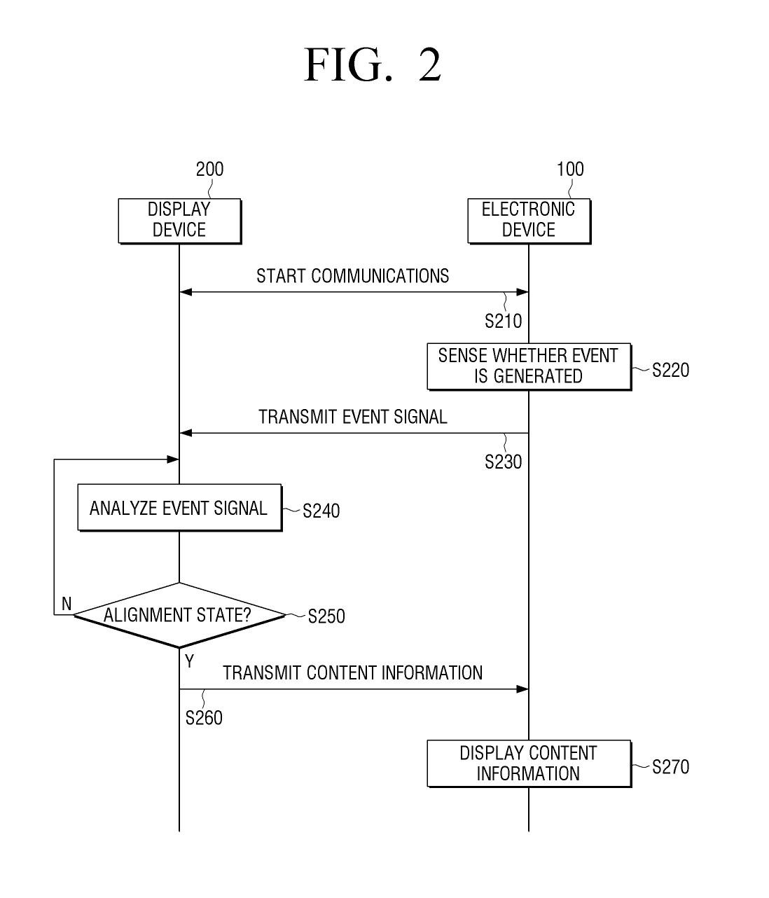

FIG. 1 is a block diagram schematically illustrating the configuration of a system that provides a content service according to an exemplary embodiment, and FIG. 2 is a procedural diagram of a system that provides a content service according to an exemplary embodiment.

As illustrated in FIG. 1, a system that provides a content service includes at least one electronic device 100 and a display device 200. Here, the display device 200 is a terminal device, such as a smart TV, but the display device 200 may be any device or apparatus that displays any type of content. The electronic device 100 is a portable terminal device, such as a smart phone, or a tablet PC, and may be any device that displays any type of content information about content that is displayed on a display device 200.

Specifically, as illustrated in FIG. 2, when data communications between the electronic device 100 and the display device 200 start (S210), the electronic device 100 senses whether an event related to a content service is generated (S220). According to one or more exemplary embodiments, the electronic device 100 may request a response message from a plurality of terminal devices that exist on the same network through a broadcasting method, and the terminal device that has received such a request message may transmit the response message to the electronic device 100. Also, the electronic device 100 may search for terminal devices that exist on the same network based on the received response message, and display a list of the searched terminal devices on a screen. Thereafter, a user may select a display device that will perform data communications related to the content service from the list of the searched terminal devices. Thereafter, the electronic device 100 may start communications with the display device 200 by performing pairing with the selected display device 200.

After the communications with the display device 200 starts, the electronic device 100 determines whether an event related to the content service is generated. According to one or more exemplary embodiments, if a motion is sensed through a sensor provided on the electronic device 100, the electronic device 100 determines whether the electronic device is in an alignment state for providing the content service from the display device 200 based on the result of the motion sensing. Here, the content service may be the related content information about the content that is being displayed on the display device 200. Further, the alignment state may be a motion state of the electronic device 100 for providing the content service from the display device 200.

If it is determined that the electronic device 100 is in the alignment state, the electronic device 100 transmits an event signal to the paired display device 200 (S230).

The display device 200 determines whether the display device is in the alignment state with the electronic device 100 through analysis of the event signal that is received from the electronic device 100 (S240). In an exemplary embodiment, the event signal may include alignment state information. Accordingly, the display device 200 analyzes whether the alignment state information is included in the received event signal, and if the alignment state information is included in the received event signal, the display device 200 determines that the display device is in the alignment state with the electronic device 100.

In another exemplary embodiment, the event signal may include motion sensing information that is sensed through a sensor. In this case, the display device 200 may determine whether the display device is in an alignment state based on the motion sensing information included in the received event signal. Here, the motion sensing information may be a slope value according to a motion of the electronic device 100. Accordingly, the display device 200 may compare the slope value according to the motion of the electronic device 100 with a predetermined slope value, and may determine that the display device is in the alignment state with the electronic device 100 if the slope value according to the motion of the electronic device 100 is equal to or larger than the predetermined slope value.

In another exemplary embodiment, if the alignment state information is not included in the event signal, the display device 200 may sense a distance between the electronic device 100 and the display device 200 through at least one of an ultrasonic sensor and a BLE (Bluetooth Low Energy) sensor, and may determine that the display device 200 is in the alignment state with the electronic device 100 if the sensed distance is within a predetermined threshold distance. If it is determined that the display device 200 is in the alignment state with the electronic device 100 through various exemplary embodiments as described above, the display device 200 transmits the content information related to the content that is currently being displayed to the paired electronic device 100, and the electronic device 100 displays the content information that is received from the display device according to a user command on a screen (S260 and S270).

As described above, through the system that provides the content service according to an exemplary embodiment, a user can receive the content information related to the content that is being displayed on the display device 200 through the electronic device 100 more conveniently and quickly.

Above, the operation of the system that provides the content service according to one or more exemplary embodiments has been briefly described. Hereinafter, the respective configurations of the electronic device 100 and the display device 200 will be described in more detail.

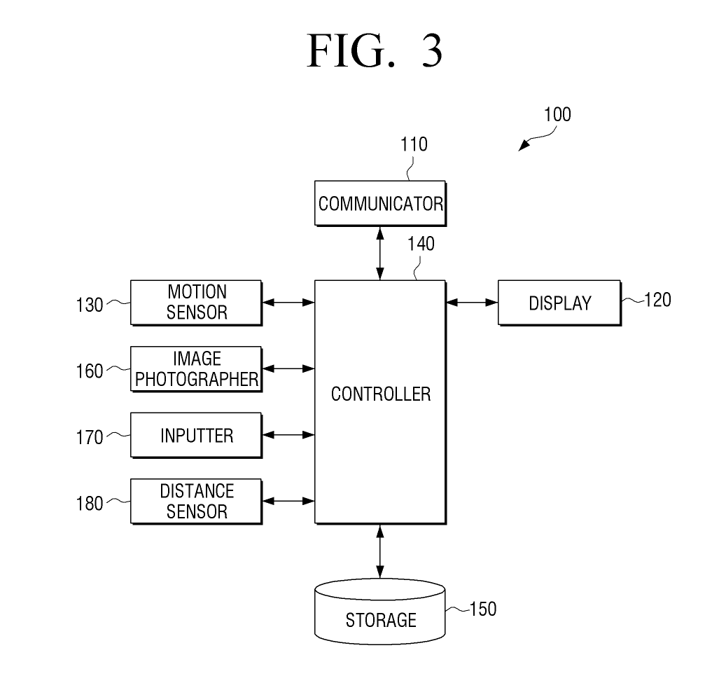

FIG. 3 is a block diagram of an electronic device according to an exemplary embodiment.

As illustrated in FIG. 3, an electronic device 100 includes a communicator 110, a display 120, a motion sensor 130, a controller 140, a storage 150, an image capturer 160, and an inputter 170.

The communicator 110 performs wireless data communications with the display device 200 that displays content. Further, the communicator 110 performs wireless data communications with peripheral terminal devices that exist on the same network.

The communicator 110 may include various communication modules, such as a near field communication module and a wireless communication module. Here, the near field communication module performs wireless near field communications with the display device 200 and the peripheral terminal devices, and may be implemented by at least one of a Bluetooth module, IrDA (Infrared Data Association) module, an NFC (Near Field Communication) module, a Wi-Fi module, and a Zigbee module. The wireless communication module is a module that is connected to an external network according to a wireless communication protocol, such as Wi-Fi or IEEE, to perform communications. In addition, the wireless communication module may further include a mobile communication module that is connected to a mobile communication network to perform communications according to various mobile communication standards, such as 3G (3^{rd} Generation), 3GPP (3^{rd} Generation Partnership Protocol), and LTE (Long Term Evolution).

The display 120 displays video-processed content and OSD information about the screen. The display 120 may be integrally formed with a touch panel that receives a user's touch commands.

The motion sensor 130 senses a motion of the electronic device 100. According to one or more exemplary embodiments, the motion sensor 130 may be implemented by a six-axis sensor that uses technical features of an acceleration sensor that recognizes a spatial motion and a geometric sensor that senses directivity. The motion sensor 130 that is implemented by such a six-axis sensor senses the motion of the electronic device 100 according to a user's operation, and generates corresponding motion sensing information. Here, the motion sensing information that is sensed through the motion sensor 130 may be a slope value according to the motion of the electronic device 100.

The controller 140 controls the operations of the constituent elements of the electronic device 100. In particular, the controller 140 determines whether the electronic device is in the alignment state for providing the content service from the display device 200 based on the motion sensing result sensed through the motion sensor 130. If the electronic device is in the alignment state as the result of the determination, the controller 140 transmits an event signal that includes alignment state information to the display device 200 through the communicator 110.

According to an exemplary embodiment, the controller 140 may compare a slope value that is sensed through the motion sensor 130 with a predetermined slope value, and may determine that the electronic device is in the alignment state for providing the content service from the display device 200 if the sensed slope value is equal to or larger than the predetermined slope value. Here, the predetermined slope value may be stored in the storage 150.

The storage 150 that stores the predetermined slope value as described above is a storage medium in which various kinds of programs that are required to operate the electronic device 100 are stored, and may be implemented by a memory or a HDD (Hard Disk Drive). For example, the storage 150 may include a ROM for storing programs for the operation of the controller 140 and a RAM for temporarily storing data according to the operation of the controller 140. Further, the storage 150 may further include an EEPRM (Electrically Erasable and Programmable ROM) for storing various kinds of reference data.

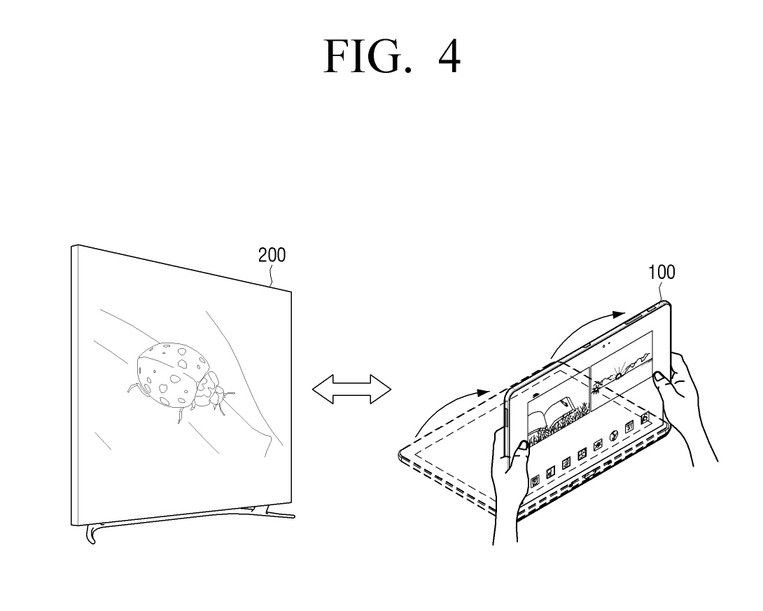

FIG. 4 is an exemplary view illustrating an alignment state between an electronic device according to an exemplary embodiment and a display device.

As illustrated in FIG. 4, the electronic device 100 may be held horizontally (or it may be put on a flat surface, e.g., a table), and the display device 200 may display the content requested by the user.

In a state in which the content is displayed on the display device 200, a user may move the electronic device 100 from a horizontal position in a vertical direction. If the electronic device 100 that is in a horizontal position moves in the vertical direction, the motion sensor 130 of the electronic device 100 may calculate the slope value through sensing the motion of the electronic device 100. The slope value may be a numerical value corresponding to an amount of rotation that occurs when an electronic device 100 is rotated, e.g., angle of rotation.

If the slope value is calculated through the motion sensor 130, the controller 140 may determine whether the electronic device is in the alignment state for providing the content service by determining whether the sensed slope value is equal to or larger than the predetermined slope value through comparison of the calculated slope value with the predetermined slope value that is pre-stored in the storage 150. If it is determined that the electronic device is in the alignment state, the controller 140 transmits the event signal that includes the alignment state information to the display device 200 through the communicator 110.

According to another exemplary embodiment, if a motion is sensed through the motion sensor 130, the controller 140 may transmit the event signal that includes the sensed motion information to the display device 200 through the communicator 110. In this case, the controller 140 does not determine whether the electronic device 100 is in the alignment state based on the motion information that is sensed through the motion sensor 130, but the display device 200 determines whether the display device 200 is in the alignment state with the electronic device 100 based on the event signal.

According to another exemplary embodiment, the controller 140 may determine whether the electronic device is in the alignment state with the display device 200 according to a similarity between a photographed image of the display device 200 that is photographed through the image capturer 160 that photographs an image and a predetermined video image of the display device 200 that is pre-stored in the storage 150. According to an exemplary embodiment, as illustrated in FIG. 4, if the electronic device 100 that is in the horizontal direction moves in the vertical direction, the motion sensor 130 can sense the motion according to the movement of the electronic device 100. If the motion is sensed through the motion sensor as described above, the controller 140 controls the image capturer 160 to photograph an image of a peripheral environment. In accordance with such a control command, the image capturer 160 may photograph an image of the peripheral environment including the display device 200.

Accordingly, the controller 140 measures the similarity between the photographed image of the display device 200 that is photographed through the image capturer 160 and the predetermined video image of the display device 200 that is pre-stored in the storage 150. Thereafter, the controller 140 compares a similarity value according to a similarity measurement of the photographed image of the display device 200 and the video image with a predetermined similarity value, and determines that the electronic device 100 is in the alignment state if the measured similarity value is equal to or larger than the predetermined similarity value.

Additionally, according to an additional aspect of the present disclosure, the electronic device 100 may further include a distance sensor 180. Here, the distance sensor 180 may sense a distance between the electronic device 100 and the display device 200, and may include at least one of an ultrasonic sensor and a BLE (Bluetooth Low Energy) sensor. In the case of sensing the distance between the electronic device 100 and the display device 200 through the ultrasonic sensor, the ultrasonic sensor may be formed in at least two edge regions of the electronic device 100. Accordingly, the controller 140 may compare distance information sensed through the distance sensor 180 with threshold distance information pre-stored in the storage 150, and if the sensed distance information is within the predetermined threshold distance, the controller 140 may determine that the electronic device is in the alignment state for providing the content service.

If it is determined that the electronic device is in the alignment state for providing the content service through various exemplary embodiments as described above, the controller 140 transmits an event signal that includes alignment state information to the display device 200 through the communicator 110. The event signal that is transmitted to the display device 200 through the various exemplary embodiments as described above may be an IR signal.

Additionally, if the content information about the content is received from the display device 200 that has transmitted the event signal, the controller 140 controls the display 120 to display the content information that is received from the display device 200. Here, the content information may be additional information about the content that is being displayed on the display device 200. Accordingly, the display 120 may display the content information that is received from the display device 200 on the screen, or may display an icon or a notification message on the screen, which notifies that the corresponding content information has been received.

Specifically, if the event signal is received from the electronic device 100, the display device 200 transmits a corresponding response message to the electronic device 100 that has transmitted the event message. Accordingly, the controller 140 transmits the event signal to the display device 200 through the communicator 110, and then determines whether a response message for notifying that the event signal has been received is received from the display device 200 within a predetermined threshold time. If the response message for notifying that the event signal has been received is not received within the predetermined threshold time as the result of the determination, the controller 140 may retransmit the event signal to the display device 200 through the communicator 110.

Additionally, if the event signal is received from the electronic device 100, the display device 200 transmits the response message for notifying that the event signal has been received to the electronic device 100, and then transmits the content information related to the content that is currently being displayed to the electronic device 100. Here, the content information may be additional information about the content that is being displayed on the display device 200. For example, in a case in which drama-related content is displayed on the display device 200, the display device 200 may transmit content information, such as a summary and details about characters of a drama that is being displayed, to the electronic device 100.

If the content information is received, the controller 140 operates to display an icon or a notification message on the screen, which notifies that the content information has been received. Accordingly, the display 120 may display the icon or the notification message, which notifies that the content information has been received, on the screen. If a selection command for the icon or the notification message is input through the inputter 170, such as an operation portion or a touch panel provided on the electronic device 100 in a state in which the icon or the notification message is displayed, the controller 140 controls the display 120 to display the content information that is received from the display device 200. Accordingly, the display 120 may display the content information related to the content that is being displayed on the display device 200.

Accordingly, the user can be provided with the content information related to the content that is currently being displayed through the electronic device 100 while viewing the content through the display device 200.

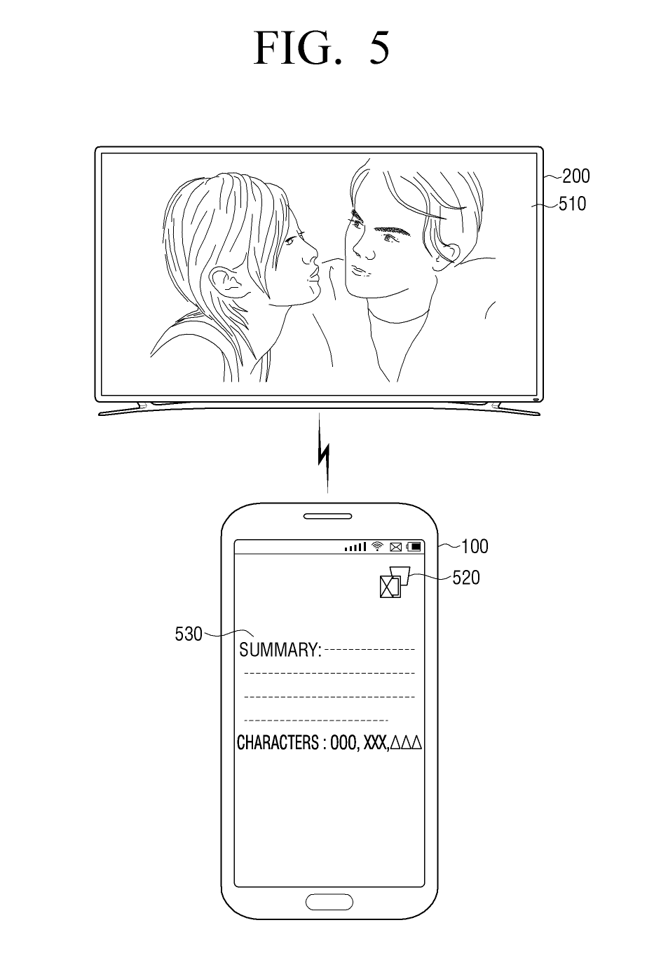

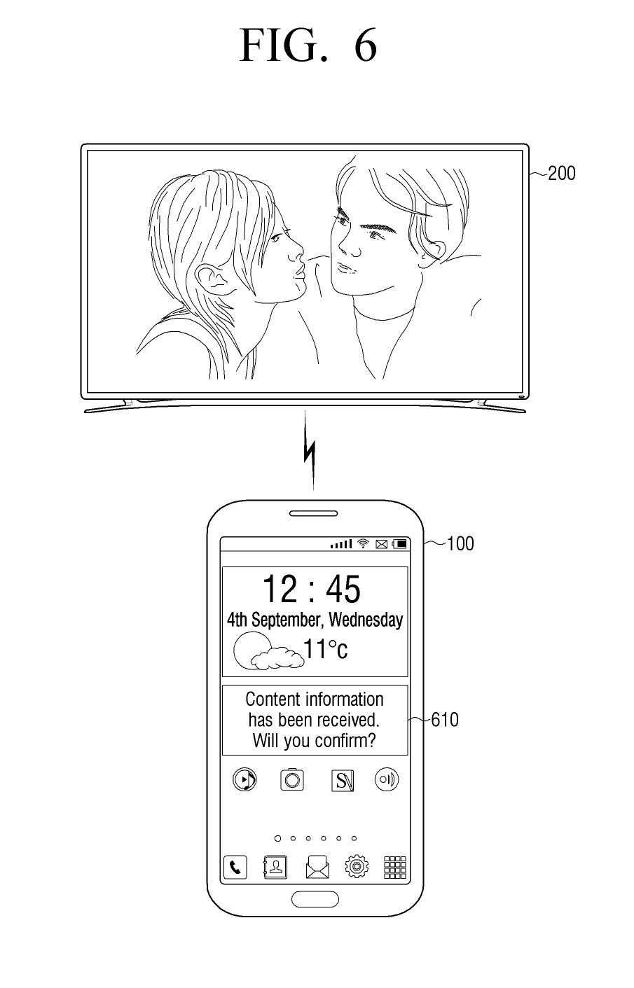

Hereinafter, referring to FIGS. 5 and 6, the operation of the electronic device to provide the content information will be described in detail.

FIG. 5 is a first exemplary view of an electronic device that provides content information according to an exemplary embodiment.

As illustrated in FIG. 5, if the electronic device 100 is in the alignment state with the display device 200, the controller 140 transmits event information that includes alignment state information to the display device 200. If the event information is received from the electronic device 100, the display device 200 transmits a notification message for notifying that the event information has been received to the electronic device 100, and then transmits content information related to content that is currently being displayed to the electronic device 100.

For example, the display device 200 may receive content related to drama “movie” 510, which is one of a plurality of pieces of content provided from a content server, through a channel that is selected by the user, and may display the received content on the screen. If the event information is received from the electronic device 100 in a state in which the drama “movie” 510 is displayed, the display device 200 transmits the content information related to the drama “movie” 510 to the electronic device 100.

If the content information related to the drama “movie” 510 is received from the display device 200, the controller 140 controls the display 120 to display the icon for notifying that the content information has been received. Accordingly, the display 120 may display the icon 520 for notifying that the content information related to the drama “movie” 510 has been received on one side region of the screen. Thereafter, if a selection command for the icon 520 that is displayed on one side region of the screen is input through the inputter 170, such as a touch panel, the controller 140 controls the display 120 to display the content information received from the display device 200 on the screen.

Accordingly, the display 120 displays the content information that is received from the display device 200 on the screen. In this case, on the screen of the electronic device 100, the content information 530 on the summary and characters related to the drama “movie” 510 that is being displayed on the display device 200 is displayed.

Accordingly, the user can be provided with the content information about the summary and characters related to the drama “movie” 510 through the electronic device 100 while viewing the drama “movie” 510 through the display device 200.

FIG. 6 is a second exemplary view of an electronic device that provides content information according to another exemplary embodiment.

As described above with reference to FIG. 5, if the content information related to the drama “movie” 510 is received from the display device 200, the controller 140 controls the display 120 to display a notification message for notifying that the content information has been received. Accordingly, the display 120 may display the notification message “Content information has been received. Will you confirm?” 610 on the screen. Thereafter, if a selection command for the notification message 610 that is displayed on one side region of the screen is input through the inputter 170, such as a touch panel, the controller 140 controls the display 120 to display the content information received from the display device 200 on the screen.

Accordingly, the display 120 displays the content information that is received from the display device 200 on the screen. In this case, on the screen of the electronic device 100, as described above with reference to FIG. 5, the content information 530 on the summary and characters related to the drama “movie” 510 that is being displayed on the display device 200 is displayed.

Above, the configuration of an electronic device 100 according to the present disclosure has been described in detail. Now, the configuration of a display device 200 according to the present disclosure will be described in detail.

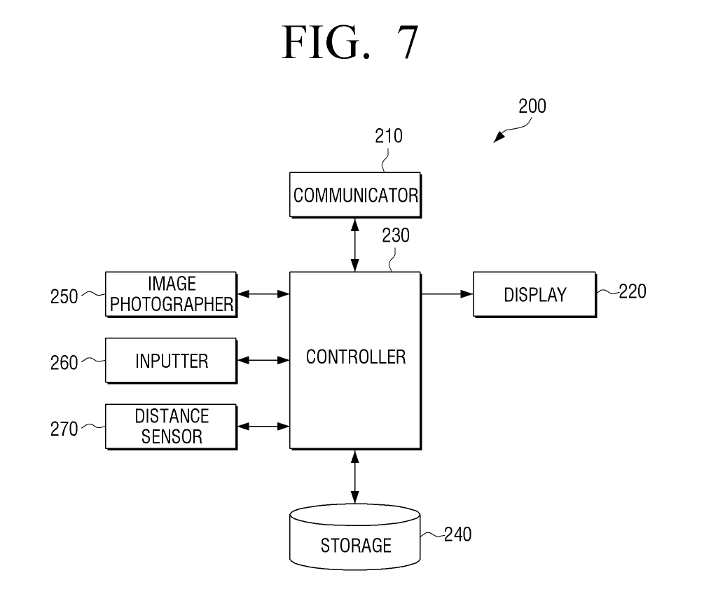

FIG. 7 is a block diagram of a display device according to an exemplary embodiment.

As illustrated in FIG. 7, the display device 200 includes a communicator 210, a display 220, a controller 230, a storage 240, an image capturer 250, and an inputter 260.

The communicator 210 may perform wired or wireless communications with a content server that provides content to receive the content requested by a user. Further, the communicator 210 may perform wireless communications with the electronic device 100, which is paired to start the communications, among a plurality of peripheral terminal devices to transmit the content information of the content that is being displayed. In the case of transmitting the content information to the paired electronic device 100, the communicator 210 may transmit the content information to the electronic device 100 using at least one communication method of Bluetooth, BLE (Bluetooth Low Frequency), UPNP (Universal Plug and Play), HTTP (Hypertext Transfer Protocol), and Wi-Fi.

The display 220 displays the content that is received from the content server. The display 220 may be implemented by a LCD (Liquid Crystal Display), OLED (Organic Light Emitting Display), and PDP (Plasma Display Panel), and may provide various display screens that can be provided through the display device 200.

The inputter 260 receives a user command that is input from an input means, such as an operation portion or a touch panel provided on the electronic device 100, and transfers the user command to the controller 230. The controller 230 may control the operation of the display device 200 or may receive the content from the content server based on the user command that is input through the inputter 260.

The controller 230 controls the operations of the constituent elements of the display device 200. In particular, the controller 230 transmits the content information that is pre-stored in relation to the content that is being displayed through the display 220 to the electronic device 100 that has transmitted the event signal based on the event signal that is received from the electronic device 100 through the communicator 210.

Specifically, if the event signal is received, the controller 230 determines whether the event signal includes alignment state information through analysis of the received event signal. If the event signal includes the alignment state information as the result of the determination, the controller 230 controls the communicator 210 to transmit the content information that is pre-stored in relation to the content that is being displayed through the display 220 to the electronic device 100.

Additionally, if motion information of the electronic device 100 is included in the received event signal, the controller 230 determines whether the slope value included in the motion information is equal to or larger than the slope value that is pre-stored in the storage 240. If the slope value included in the motion information is equal to or larger than the pre-stored slope value as the result of the determination, the controller 230 determines that the electronic device 100 is in the alignment state, and controls the communicator 210 to transmit the content information that is pre-stored in relation to the content that is being displayed through the display 220 to the electronic device 100.

According to an additional aspect of the present disclosure, the display device 200 may further include a distance sensor 270 that senses the distance between the display device 200 and the electronic device 100. Accordingly, the controller 230 may determine whether the electronic device 100 is in the alignment state based on distance information sensed through the distance sensor 270. Here, the distance sensor 270 may sense the distance between the display device 200 and the electronic device 100, and may include at least one of an ultrasonic sensor and a BLE (Bluetooth Low Energy) sensor. In the case of sensing the distance between the display device 200 and the electronic device 100 through the ultrasonic sensor, the ultrasonic sensor may be formed in at least two edge regions of the electronic device 100. Accordingly, the controller 230 may compare distance information sensed through the distance sensor 270 with threshold distance information pre-stored in the storage 240, and the controller 230 may determine whether the electronic device 100 is in the alignment state depending on whether the sensed distance information is within the predetermined threshold distance.

Specifically, if the alignment state information is not included in the event signal that is received from the electronic device 100, the controller 230 determines whether the distance information that is sensed through the distance sensor 270 is within the predetermined threshold distance. If the sensed distance information is within the predetermined threshold distance as the result of the determination, the controller 230 determines that the electronic device 100 is in the alignment state, and controls the communicator 210 to transmit the content information that is pre-stored in relation to the content that is being displayed through the display 220 to the electronic device 100. According to an additional aspect of the present disclosure, the controller 230 may determine whether the electronic device 100 is in the alignment state depending on the degree of similarity between a photographed image of the electronic device 100 that is photographed through the image capturer 250 and a video image of the electronic device 100 that is pre-stored in the storage 240.

Specifically, if an event signal that does not include the alignment state information is received from the electronic device 100, the controller 230 controls the image capturer 250 to photograph an image of a peripheral environment. In accordance with such a control command, the image capturer 250 may photograph an image of the peripheral environment including the electronic device 100. Here, the event signal may be a signal according to motion sensing of the electronic device 100 or a content service related control signal. If the event signal is received, the controller 230 measures the similarity between the photographed image of the electronic device 100 that is photographed through the image capturer 250 and the video image of the electronic device 100 that is pre-stored in the storage 240. Thereafter, the controller 230 compares a similarity value according to a similarity measurement of the photographed image of the electronic device 100 and the pre-stored video image with a predetermined similarity value, and determines that the electronic device is in the alignment state if the measured similarity value is equal to or larger than the predetermined similarity value. If it is determined that the electronic device is in the alignment state as the result of the determination, the controller 230 controls the communicator 210 to transmit the content information that is pre-stored in relation to the content that is being displayed through the display 220 to the electronic device 100.

According to an additional aspect of the present disclosure, if a content transmission command is input from the user through the inputter 260 in a state in which the event signal that does not include the alignment state information is received, the controller 230 controls the communicator 210 to transmit the content information that is pre-stored in relation to the content that is being displayed through the display 220 to the electronic device 100.

Additionally, the communicator 210 may transmit the content information to the electronic device 100 using at least one communication method of Bluetooth, BLE (Bluetooth Low Energy), UPNP (Universal Plug and Play), HTTP (Hypertext Transfer Protocol), and Wi-Fi. Here, the content information is additional information about the content that is being displayed on the display 220, and may be received from the content server together with the corresponding content. For example, if the content that is received from the content server is a drama “movie”, the content information may be additional information about the summary and characters of the drama “movie”.

As described above, if the event signal is received from the electronic device 100, the controller 230 may transmit a notification message for notifying that the event signal has been received before the content information is transmitted to the electronic device 100 through the communicator 210. Through such a notification message, the electronic device 100 can determine whether the content service related event signal has been normally received in the display device 200. If the notification message for notifying that the event signal has been received is not received from the display device 200 within a predetermined threshold time after the event signal is transmitted to the display device 200 as the result of the determination, the electronic device 100 may retransmit the event signal to the display device 200.

Now, a method for providing a content service through the electronic device 100 and the display device 200 according to the present disclosure will be described in detail.

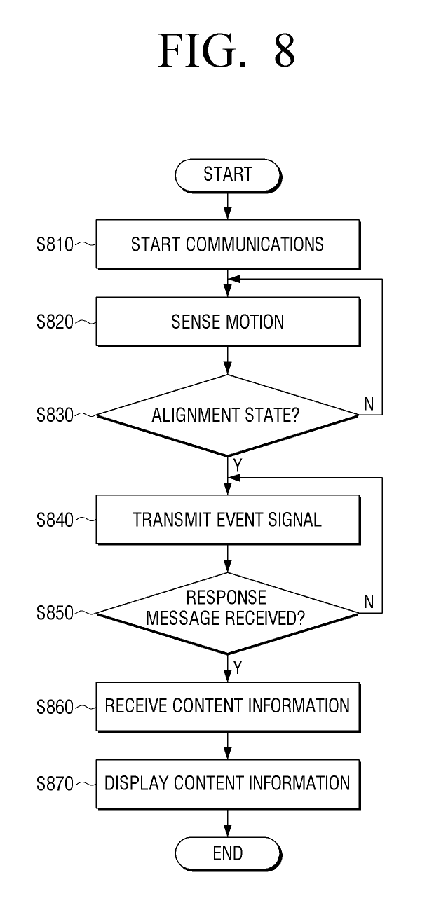

FIG. 8 is a flowchart illustrating a method for controlling an electronic device according to an exemplary embodiment.

As illustrated in FIG. 8, in order to receive content information from the display device 200, the electronic device 100 performs pairing with the display device 200 (S810). According to one or more exemplary embodiments, the electronic device 100 may request a response message from a plurality of terminal devices that exist on the same network through a broadcasting method, and the terminal device that has received such a request message may transmit a response message to the electronic device 100. Accordingly, the electronic device 100 may search for terminal devices that exist on the same network based on the received response message, and may display a list of the searched terminal devices on a screen. Thereafter, a user may select a display device 200 that will perform data communications related to the content service from the list of the searched terminal devices. Thereafter, the electronic device 100 may start communications with the display device 200 through performing pairing with the selected display device 200.

Thereafter, the electronic device 100 senses a motion of the electronic device 100 through a motion sensor, and determines whether the electronic device 100 is in an alignment state for providing a content service from the display device 200 based on the motion sensing result (S820 and S830). If the electronic device 100 is in the alignment state as the result of the determination, the electronic device 100 generates an event signal that includes alignment state information and transmits the generated event signal to the display device 200 (S840).

According to an exemplary embodiment, the electronic device 100 may compare a slope value that is sensed through a motion sensor with a predetermined slope value, and may determine that the electronic device 100 is in the alignment state for providing the content service from the display device 200 if the sensed slope value is equal to or larger than the predetermined slope value. If it is determined that the electronic device 100 is in the alignment state, the electronic device 100 transmits the event signal that includes the alignment state information to the display device 200.

According to another exemplary embodiment, the electronic device 100 may determine whether the electronic device is in the alignment state depending on the similarity between a photographed image of the display device 200 that is photographed through a provided camera and a pre-stored video image of the display device 200. According to one or more exemplary embodiments, as described above with reference to FIG. 4, if the electronic device 100 that is in a horizontal direction moves in a vertical direction, the motion sensor may sense a motion according to movement of the electronic device. If a motion is sensed through the motion sensor, the camera may photograph an image of a peripheral environment including the display device 200.

Accordingly, the electronic device 100 measures the similarity between the photographed image of the display device 200 that is photographed through the camera and the pre-stored video image of the display device 200. Thereafter, the controller 140 compares the similarity value according to the similarity measurement of the photographed image of the display device 200 and the video image with a predetermined similarity value, and determines that the electronic device 100 is in the alignment state for providing the content service if the measured similarity value is equal to or larger than the predetermined similarity value. If it is determined that the electronic device is in the alignment state, the electronic device 100 may transmit an event signal that includes the alignment state information to the display device 200.

According to another exemplary embodiment, the electronic device 100 compares distance information between the electronic device 100 and the display device 200, which is sensed through at least one of an ultrasonic sensor and a BLE (Bluetooth Low Energy) sensor, with predetermined threshold distance information. If the sensed distance information is within the predetermined threshold distance as the result of the comparison, the electronic device 100 may determine that the electronic device is in the alignment state for providing the content service, and may transmit an event signal that includes the alignment state information to the display device 200. According to another exemplary embodiment, if a motion is sensed through the motion sensor, the electronic device may generate an event signal that includes the sensed motion information to transmit the generated event signal to the display device 200. In some cases, the electronic device 100 might not internally determine whether the electronic device is in the alignment state based on the sensed motion information, but the display device 200 may determine whether the display device is in an alignment state with the electronic device 100 based on the event signal.

Additionally, the event signal that is transmitted to the display device 200 may be an IR signal. If the event signal that is the IR signal is received, the display device 200 transmits a notification message to the electronic device 100 notifying that the event signal has been received. Accordingly, the electronic device 100 transmits the event signal to the display device 200, and then determines whether the notification message is received from the display device 200 within a predetermined threshold time (S850). If the notification message is not received from the display device 200 within the predetermined threshold time as the result of the determination, the electronic device 100 may retransmit the event signal to the display device 200 by re-performing the above-described steps (S840).

Additionally, the display device 200 transmits the content information related to the content that is currently being displayed to the electronic device 100 after transmitting the notification message for notifying that the event signal has been received to the electronic device 100. Accordingly, if the content information is received from the display device 200, the electronic device 100 displays the received content information about the screen (S860 and S870).

According to one or more exemplary embodiments, if the content information is received from the display device 200, the electronic device 100 displays an icon or a notification message for notifying that the content information has been received on the screen. Thereafter, if a selection command for the icon or the notification message that is displayed on the screen of the electronic device 100 is input by a user, the electronic device 100 displays the content information that is received from the display device 200. Accordingly, the electronic device 100 can display the content information related to the content that is being displayed on the display device 200.

Accordingly, the user can be provided with the content information related to the content that is currently being displayed through the electronic device 100 while viewing the content through the display device 200.

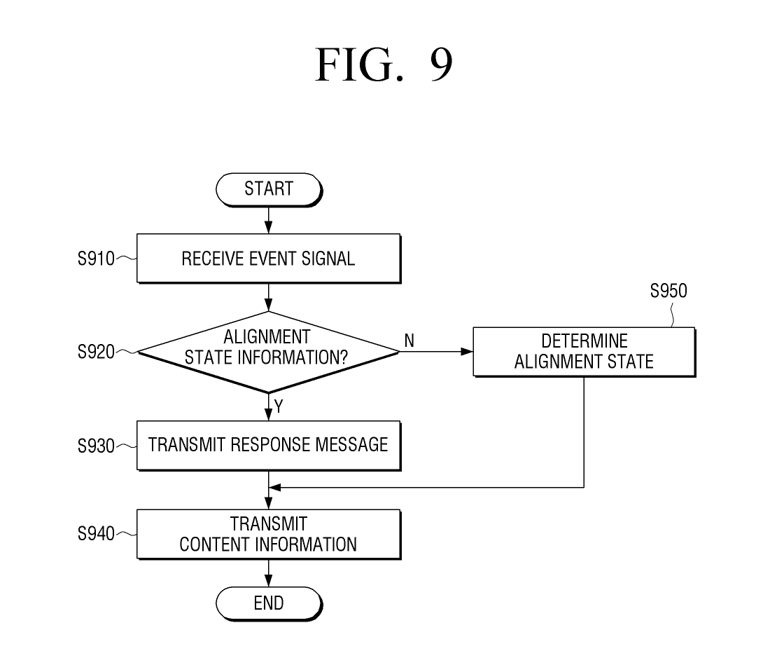

FIG. 9 is a flowchart illustrating a method for controlling a display device according to an exemplary embodiment of the present disclosure.

As illustrated in FIG. 9, if an event signal is received from the paired electronic device 100, the display device 200 determines whether the received event signal includes alignment state information for providing a content service through analysis of the received event signal (S910 and S920). If the event signal includes the alignment state information as the result of the determination, the display device 200 transmits a notification message for notifying that the event signal has been received to the electronic device 100 (S930). However, the present disclosure is not limited thereto. If the event signal is received, the display device 200 may transmit the notification message for notifying that the event signal has been received to the electronic device 100 before analyzing the alignment state information of the received event signal.

Additionally, if the event signal includes the alignment state information in S920, the display device 200 transmits the notification message in S930, and then transmits content information related to content that is being displayed to the electronic device (S940).

Additionally, if the event signal does not include the alignment state information, the display device 200 determines whether the electronic device 100 is in an alignment state through the following exemplary embodiments (S950).

According to an exemplary embodiment, the event signal that is received from the electronic device 100 may include motion information of the electronic device 100. In this case, the display device 200 determines whether the electronic device 100 is in the alignment state based on the motion information. Specifically, the display device 200 determines whether a slope value included in the motion information is equal to or larger than a pre-stored slope value through comparison of the slope value included in the motion information with the pre-stored slope value. If the slope value included in the motion information is equal to or larger than the pre-stored slope value as the result of the determination, the display device 200 determines that the electronic device 100 is in the alignment state, and transmits the content information related to the content that is being displayed to the electronic device 100.

According to another exemplary embodiment, if the alignment state information is not included in the received event signal, the display device 200 senses a distance between the display device 200 and the electronic device 100 through at least one of an ultrasonic sensor and a BLE sensor, and compares the sensed distance information with predetermined threshold distance information. If the sensed distance information is within the predetermined threshold distance information as the result of the comparison, the display device 200 may determine that the electronic device 100 is in the alignment state, and may transmit the content information related to the content that is being displayed to the electronic device 100. According to still another exemplary embodiment, if the alignment state information is not included in the received event signal, the display device 200 measures similarity between a photographed image of the electronic device 100 that is photographed through a camera provided on the display device 200 and a pre-stored video image of the electronic device 100. Thereafter, the display device 200 compares the similarity value according to the similarity measurement of the photographed image of the electronic device 100 and the pre-stored video image of the electronic device 100 with a predetermined similarity value. If the measured similarity value is equal to or larger than the predetermined similarity value, thee display device 200 may determine that the electronic device is in the alignment state for providing a content service, and may transmit the content information related to the content that is being displayed to the electronic device 100.

According to still another exemplary embodiment, if a content transmission command is input from the user in a state in which the alignment state information is not included in the received event signal, the display device 200 may transmit the content information related to the content that is being displayed to the electronic device 100.

Accordingly, if the content information is received from the display device 200, the electronic device 100 displays an icon or a notification message for notifying that the content information has been received on the screen. Thereafter, if a selection command for the icon or the notification message, which is displayed on the screen of the electronic device 100, is input by the user, the electronic device 100 displays the content information that is received from the display device 200. Accordingly, the electronic device 100 can display the content information related to the content that is being displayed on the display device 200 on the screen.

Accordingly, the user can be provided with the content information related to the content that is currently being displayed through the electronic device 100 while viewing the content through the display device 200.

While the present disclosure has been shown and described with reference to certain exemplary embodiments thereof, it will be understood by those skilled in the art that various changes in form and detail may be made therein without departing from the spirit and scope of the present disclosure, as defined by the appended claims.

What is claimed is:

1. A method of controlling an electronic device, the method comprising:
communicating with a display device that displays content;
sensing a motion of the electronic device;
determining whether the electronic device is in an alignment state based on the motion sensing;
transmitting an event signal that includes alignment state information to the display device; and
receiving and displaying content information related to the displayed content.

2. The method as claimed in claim 1, further comprising comparing a slope value sensed through the electronic device with a predetermined slope value, and determining that the electronic device is in the alignment state if the sensed slope value is equal to or larger than the predetermined slope value.

3. The method as claimed in claim 1, further comprising measuring a similarity between an image of the display device that is captured through an image capturer of the electronic device and a predetermined image of the display device, and determining that the electronic device is in the alignment state if the measured similarity value is equal to or greater than a predetermined similarity value.

4. The method as claimed in claim 1, further comprising sensing a distance between the electronic device and the display device through at least one of an ultrasonic sensor and a BLE (Bluetooth Low Energy) sensor, and determining that the electronic device is in the alignment state if the sensed distance is within a predetermined threshold distance.

5. The method as claimed in claim 1, further comprising displaying an icon indicating that the content information has been received from the display device, and in response to receiving an input selection command for the displayed icon, displaying the content information related to the content.

6. The method as claimed in claim 1, further comprising retransmitting the event signal to the display device if a response message is not received from the display device within a predetermined threshold time after the event signal is transmitted to the display device.

7. A method of controlling a display device, the method comprising:
receiving an event signal from an electronic device;
determining whether the received event signal includes alignment state information; and
transmitting content information about content being displayed on the display device to the electronic device if the event signal includes the alignment state information.

8. The method as claimed in claim 7, further comprising, if the received event signal includes motion information, determining whether the electronic device is in an alignment state according to whether a slope value included in the motion information of the electronic device is equal to or greater than a predetermined slope value, and
transmitting the content information to the electronic device if the electronic device is in the alignment state.

9. The method as claimed in claim 7, further comprising, if the received event signal does not include the alignment state information, sensing a distance between the electronic device and the display device through at least one of an ultrasonic sensor and a BLE (Bluetooth Low Energy) sensor, and determining that the electronic device is in the alignment state if the sensed distance is within a predetermined threshold distance, and
transmitting the content information to the electronic device if the electronic device is in the alignment state.

10. The method as claimed in claim 7, further comprising, if the received event signal does not include the alignment state information, determining whether the electronic device is in the alignment state according to a degree of similarity between an image of the electronic device that is captured through an image capturer provided in the display device and a predetermined image of the electronic device, and
transmitting the content information to the electronic device if the electronic device is in the alignment state.

11. The method as claimed in claim 7, further comprising, if the received event signal does not include the alignment state information, transmitting the content information to the electronic device if a content transmission command is input.

12. The method as claimed in claim 7, further comprising transmitting a notification message to the electronic device before transmitting the content information, indicating that the event signal has been received.

13. The method as claimed in claim 7, further comprising transmitting the content information using a communication method including at least one of Bluetooth, BLE (Bluetooth Low Energy), UPNP (Universal Plug and Play), HTTP (Hypertext Transfer Protocol), and Wi-Fi.

14. An electronic device comprising:
a display;
a sensor configured to sense a motion of the electronic device;
a communicator configured to communicate with a display device that displays content; and
a controller configured to:
determine whether the electronic device is in an alignment state for providing a content service from the display device based on a result of the motion sensing,
transmit an event signal that includes alignment state information to the display device, and
control the display to display content information related to the content that is displayed on the display device.

15. The electronic device as claimed in claim 14, wherein the controller is further configured to compare a slope value that is sensed through the sensor with a predetermined slope value, and determine that the electronic device is in the alignment state if the sensed slope value is equal to or greater than the predetermined slope value.

16. The electronic device as claimed in claim 14, further comprising an image capturer configured to capture an image,
wherein the controller is further configured to:
measure a similarity between an image that is captured through the image capturer and a predetermined image of the display device, and determine that the electronic device is in the alignment state if the measured similarity value is equal to or greater than a predetermined similarity value.

17. The electronic device as claimed in claim 14, further comprising:
an inputter configured to receive an input of a user command,
wherein the controller is further configured to, in response to receiving content information from the display device, control the display to display an icon indicating that the content information has been received, and control the display to display the content information about the content displayed on the display device if a selection command for the displayed icon is input.

18. The electronic device as claimed in claim 14, wherein the controller is further configured to, in response to not receiving a response message from the display device within a predetermined threshold time after the event signal is transmitted to the display device, control the communicator to retransmit the event signal to the display device.

19. A display device comprising:
a display configured to display content;
a communicator configured to receive an event signal from an electronic device; and
a controller configured to control the communicator to, in response to receiving an event signal that includes alignment state information of the electronic device, transmit pre-stored content information that is related to the displayed content.

20. The display device as claimed in claim 19, wherein the controller is further configured to, in response to the received event signal including motion information of the electronic device, determine whether the electronic device is in an alignment state depending on whether a slope value included in the motion information of the electronic device is equal to or greater than a predetermined slope value.

21. The display device as claimed in claim 19, further comprising an image capturer configured to capture an image,
wherein the controller is further configured to determine whether the electronic device is in the alignment state according to a degree of similarity between an image of the electronic device that is captured through the image capturer and a predetermined image of the electronic device.

22. The display device as claimed in claim 19, wherein the controller is further configured to, before transmitting the content information, control the communicator to transmit a notification message to the electronic device indicating that the event signal has been received.

23. The display device of claim 19, wherein the communicator is further configured to transmit the content information using a communication method comprising at least one of Bluetooth, BLE (Bluetooth Low Energy), UPNP (Universal Plug and Play), HTTP (Hypertext Transfer Protocol), and Wi-Fi.
